(19) United States
(12) Patent Application Publication
(10) Pub. No.: US 2026/0365244 A1
(43) Pub. Date: Nov. 19, 2026

(54) Multi-Degree-Of-Freedom Corner Module System For Distributed Drive Electric Chassis

(71) Applicant: Jilin University, Changchun (CN)

(72) Inventors: Zhenhai Gao, Changchun (CN); Hanying Zhang, Changchun (CN); Zongzhi Han, Changchun (CN); Guoying Chen, Changchun (CN); Bohua Sun, Changchun (CN); Deping Wang, Changchun (CN)

(21) Appl. No.: 19/388,970

(22) Filed: Nov. 13, 2025

(30) Foreign Application Priority Data
Mar. 21, 2025 (CN) 202510337582.0

(51) Int. Cl. B62D 21/11; B60G 3/20; B60G 3/26; B60G 7/00; B60G 7/02; B60G 13/00; B60K 7/00; B62D 7/18; B62D 17/00

(52) U.S. Cl. CPC B62D 21/11; B60G 3/20; B60G 3/26; B60G 7/005; B60G 7/008; B60G 7/02; B60G 13/005; B60K 7/0007; B62D 7/18; B62D 17/00; B60G 2200/144; B60G 2200/18; B60G 2202/42; B60G 2204/129; B60G 2204/143; B60G 2204/148; B60G 2204/41; B60G 2204/416; B60G 2204/418

(57) ABSTRACT

Disclosed is a multi-degree-of-freedom corner module system for a distributed drive electric chassis, which includes a wheel hub motor, an upper control arm assembly, a lower control arm assembly, a shock absorber assembly, a steering knuckle, and a steering mechanism. One end of the upper control arm assembly is pivotally hinged above a housing of the wheel hub motor, and the other end of the upper control arm assembly is connected to a vehicle body. The lower control arm assembly adopts a configuration of an approximately linear mechanism, one end of the lower control arm assembly is hinged below a housing of the wheel hub motor, and the other end of the lower control arm assembly is connected to the vehicle body. One end of the steering knuckle is hinged to the steering mechanism via a kinematic jointcapable of providing a plurality of rotational degrees of freedom.

### CROSS-REFERENCE TO RELATED APPLICATIONS

This application claims priority to Chinese Patent Application No. 202510337582.0, filed on Mar. 21, 2025, which is hereby incorporated by reference in its entirety.

### TECHNICAL FIELD

The present application belongs to the technical field of vehicles, and particularly relates to a multi-degree-of-freedom corner module system for a distributed drive electric chassis.

### BACKGROUND

A distributed drive electric vehicle has drive motors directly mounted within or adjacent to driving wheels, and features prominent advantages such as a short drive transmission chain, compact structure, and simplified chassis configuration. Each drive motor serves as both an information unit and a control execution unit of the vehicle, which enables significant technological innovations in fully exploiting vehicle dynamics control potential, enhancing vehicle safety, and improving driving efficiency, and provides a hardware carrier for high-performance vehicle control technologies. A corner module system integrating the driving, braking, steering, and suspension systems can effectively expand the performance boundaries of a vehicle and represents a frontier development direction of the distributed drive electric chassis configuration.

The existing corner module configurations can be classified into three types according to topological features. A first type of typical configuration integrates steering degree of freedom directly into a topological loop of an original suspension, where the steering degree of freedom is driven by a kingpin steering actuator. However, the above configuration causes different motions to be mutually coupled due to the integration of a plurality of driving joints within a single open-chain mechanism, thereby reducing reliability and load-bearing capacity of the system. A second type of configuration introduces a yoke-shaped component between a suspension and a steering knuckle to decouple the wheel hop and steering degrees of freedom. However, the component used for motion decoupling occupies a large wheel-end space, which makes the layout of suspension actuators complicated and tends to reduce the transmission performance of the mechanism. A third type of configuration disconnects a suspension system loop from a vehicle body, making the suspension system loop fully independent of a steering system, thereby forming a series topology. The above configuration enables the corner module system to achieve a 360° steering range. However, this configuration has drawbacks, including large vertical space occupation, excessive bending moments at the connection points between steering arms and a chassis, and a long steering transmission chain.

### SUMMARY

An objective of an embodiment of the present application is to provide a multi-degree-of-freedom corner module system for a distributed drive electric chassis, so as to solve the problems in the background.

The embodiment of the present application is implemented as follows: a multi-degree-of-freedom corner module system for a distributed drive electric chassis includes: a wheel hub motor, an upper control arm assembly, a lower control arm assembly, a shock absorber assembly, a steering knuckle, and a steering mechanism;
the wheel hub motor is mounted within a wheel hub;
one end of the upper control arm assembly is pivotally hinged above a housing of the wheel hub motor and is capable of performing multi-directional rotation, and the other end of the upper control arm assembly is connected to at least one of a vehicle body or a vehicle frame;
the lower control arm assembly has a function of outputting an approximately linear motion, one end of the lower control arm assembly is hinged below a housing of the wheel hub motor and is capable of performing multi-directional rotation, and the other end of the lower control arm assembly is connected to at least one of a vehicle body or a vehicle frame; and
one end of the steering knuckle is hinged to the steering mechanism via a second spherical joint, the other end of the steering knuckle is rigidly connected to a housing of the wheel hub motor, and the steering mechanism is configured to drive the steering knuckle to rotate a wheel about a kingpin axis.

Further, the corner module system is a three-degree-of-freedom parallel mechanism, including two rotational degrees of freedom and one vertical translational degree of freedom;
the wheel serves as a moving platform of the parallel mechanism, where a steering motion and a cambering motion correspond to the rotational degrees of freedom, and a wheel hopping motion corresponds to the vertical degree of freedom; and
the topology of the parallel mechanism is λS-UPS-RRS, where λ represents a Chebyshev mechanism, S represents a spherical joint, U represents a Hooke joint, R represents a revolute joint, and P represents a prismatic joint.

Further, derivative configurations of the topology include λS-UPS-RPS, λU-UPS-RRU, and λS-PUS-RRS.

Further, the upper control arm assembly includes an upper control arm body, a first spherical joint, first bushings, first connecting rods, couplers, cambering drive motors, and reducers;
one end of the upper control arm body is provided with a first mounting hole for arranging a first spherical joint, and the other end of the upper control arm body is provided with a second mounting hole for assembling the first bushing;
one end of the first connecting rod is rotatably connected to the first bushing via a second assembly shaft, and the other end of the first connecting rod is connected to the coupler via a first assembly shaft;
the couplers configured to transmit power from the cambering drive motor to the upper control arm body, thereby driving the wheel to rotate about an end of the lower control arm assembly; and
the reducer is connected in series with the cambering drive motor and functions to reduce speed and increase torque.

Further, the lower control arm assembly is a Chebyshev-lambda mechanism;
the Chebyshev-lambda mechanism includes a lower control arm body, a second connecting rod, and a third connecting rod; one end of the lower control arm body is provided with a third mounting hole for arranging a second spherical joint, thereby being hinged to the housing of the wheel hub motor; two sides of the lower control arm body are respectively provided with a third assembly shaft and a fourth assembly shaft; the third assembly shaft is rotatably connected to a fourth mounting hole of the second connecting rod via a bearing; the fourth assembly shaft is rotatably connected to a sixth mounting hole of the third connecting rod via a bearing; one end of the second connecting rod far away from the lower control arm body is provided with a fifth mounting hole, and a second bushing is fixedly sleeved in the fifth mounting hole and is rotatably connected to the vehicle frame; one end of the third connecting rod far away from the lower control arm body is provided with a seventh mounting hole, and a third bushing is fixedly sleeved in the seventh mounting hole and is rotatably connected to the vehicle frame;
a planar single-open-chain mechanism includes a fourth connecting rod, a fifth connecting rod, and a shock absorber assembly; one end of the fourth connecting rod is rotatably connected to a first lug structure of the lower control arm body through an eighth mounting hole, and the other end of the fourth connecting rod is rotatably connected to a second lug structure of the fifth connecting rod through a ninth mounting hole; another end of the fifth connecting rod is rotatably connected to an eleventh mounting hole of the shock absorber assembly through a third lug structure; a fourth bushing is mounted in a tenth mounting hole formed in a middle portion of the fifth connecting rod; and a twelfth mounting hole on the shock absorber assembly is hinged to the vehicle frame.

Another objective of the embodiment of the present application is to provide a skateboard chassis. The skateboard chassis is based on the above corner module system and includes a vehicle frame, four corner module systems, and wheels configured to mount each corner module system.

The wheel includes a wheel hub and a tire, the wheel hub motor is fixedly mounted inside the wheel hub, and the tire is sleeved on an outer periphery of the wheel hub.

The multi-degree-of-freedom corner module system for the distributed drive electric chassis provided in the embodiment of the present application has the following beneficial effects:
(1) This system has three degrees of freedom: wheel hopping, steering, and wheel cambering. For the wheel hopping degree of freedom, a compound kinematic joint (Chebyshev-lambda mechanism) is used as the lower control arm, so that the geometric kinematic characteristics of the suspension are effectively improved. An active camber control is introduced into the corner module system to improve the stability and safety of the vehicles. For example, when cornering, inclining a wheel toward an inner side of a curve is beneficial to improve lateral stability. Meanwhile, a track width can be moderately increased through a wheel camber angle adjusting mechanism, thereby reducing rollover risk. In addition, active camber angle adjustment can reduce tire wear, improve wheel adhesion, and compensate for track width variation.
(2) This system integrates driving, braking, steering, and suspension systems into a plug-and-play modular structure, enabling assembly and disassembly according to transport requirements and facilitating maintenance. Each corner module system may be regarded as a parallel robot, with all driving functions of the chassis as well as a plurality of motion modes.
(3) A structure-function integrated design is adopted. A steering limb serves as both a driving unit and a constraint to wheel motion in a case where no steering angle input exists, and occupation of a wheel-end space caused by a kingpin steering unit widely adopted in current corner modules is also avoided.
(4) The rigidity and load-bearing capacity of the suspension are improved through the introduction of over-constraint, and the system has favorable transmission characteristics and low coupling degree.
(5) The provided skateboard chassis has a plurality of motion modes, including front wheel steering, rear wheel steering, zero-radius steering, pivot steering, diagonal moving, vehicle body posture adjustment, and steering assistance brought by active wheel cambering.

### BRIEF DESCRIPTION OF THE DRAWINGS

FIG. 1 is a schematic diagram of the structure of a multi-degree-of-freedom corner module system for a distributed drive electric chassis according to an embodiment of the present application;

FIG. 2 is a schematic diagram of the structure of a multi-degree-of-freedom corner module system for a distributed drive electric chassis according to an embodiment of the present application from another perspective;

FIG. 3 is a schematic diagram of the structure of a multi-degree-of-freedom corner module system for a distributed drive electric chassis according to an embodiment of the present application from yet another perspective;

FIG. 4 is a schematic diagram of the structure of an upper control arm assembly of a multi-degree-of-freedom corner module system for a distributed drive electric chassis according to an embodiment of the present application;

FIG. 5 is a schematic diagram of the exploded structure of an upper control arm assembly of a multi-degree-of-freedom corner module system for a distributed drive electric chassis according to an embodiment of the present application;

FIG. 6 is a schematic diagram of the structure of a lower control arm assembly of a multi-degree-of-freedom corner module system for a distributed drive electric chassis according to an embodiment of the present application;

FIG. 7 is a schematic diagram of the exploded structure of a lower control arm assembly of a multi-degree-of-freedom corner module system for a distributed drive electric chassis according to an embodiment of the present application;

FIG. 8 is a schematic diagram of the structure of a lower control arm body of a multi-degree-of-freedom corner module system for a distributed drive electric chassis according to an embodiment of the present application;

FIG. 9 is a schematic diagram of a skateboard chassis passing over a bumpy road surface according to an embodiment of the present application;

FIG. 10 is a schematic diagram of four-wheel steering of a skateboard chassis according to an embodiment of the present application;

FIG. 11 is a schematic diagram of front wheel cambering of a skateboard chassis according to an embodiment of the present application;

FIG. 12 is a schematic diagram of rear wheel cambering of a skateboard chassis according to an embodiment of the present application; and

FIG. 13 is a schematic diagram of all-wheel cambering of a skateboard chassis according to an embodiment of the present application.

Reference numerals: 100. skateboard chassis; 200. road surface bump; 10. wheel; 11. wheel hub; 12. tire; 20. corner module system; 21. wheel hub motor; 211. wheel hub motor housing; 22. upper control arm assembly; 221. upper control arm body; 2211. first mounting hole; 2212. second mounting hole; 222. first spherical joint; 223. first bushing; 224. first connecting rod; 2241. first assembly shaft; 2242. second assembly shaft; 225. coupler; 226. cambering drive motor; 227. reducer; 23. lower control arm assembly; 231. lower control arm body; 2311. third mounting hole; 2312. third assembly shaft; 2313. fourth assembly shaft; 2314. first lug structure; 2315. bearing; 232. second spherical joint; 233. second connecting rod; 2331. fourth mounting hole; 2332. fifth mounting hole; 234. third connecting rod; 2341. sixth mounting hole; 2342. seventh mounting hole; 235. fourth connecting rod; 2351. eighth mounting hole; 2352. ninth mounting hole; 236. fifth connecting rod; 2361. second lug structure; 2362. third lug structure; 2363. tenth mounting hole; 237. second bushing; 238. third bushing; 239. fourth bushing; 24. shock absorber assembly; 241. eleventh mounting hole; 242. twelfth mounting hole; 25. steering knuckle; 26. steering mechanism; 30. vehicle frame; and A. kingpin axis.

### DESCRIPTION OF EMBODIMENTS

To make the objectives, technical solutions and advantages of the present application more apparent, the present application is further described in detail below with reference to the accompanying drawings and embodiments. It should be understood that the specific embodiments described herein are merely illustrative of the present application and do not limit the present application.

Specific implementations of the present application are described in detail below with reference to specific embodiments.

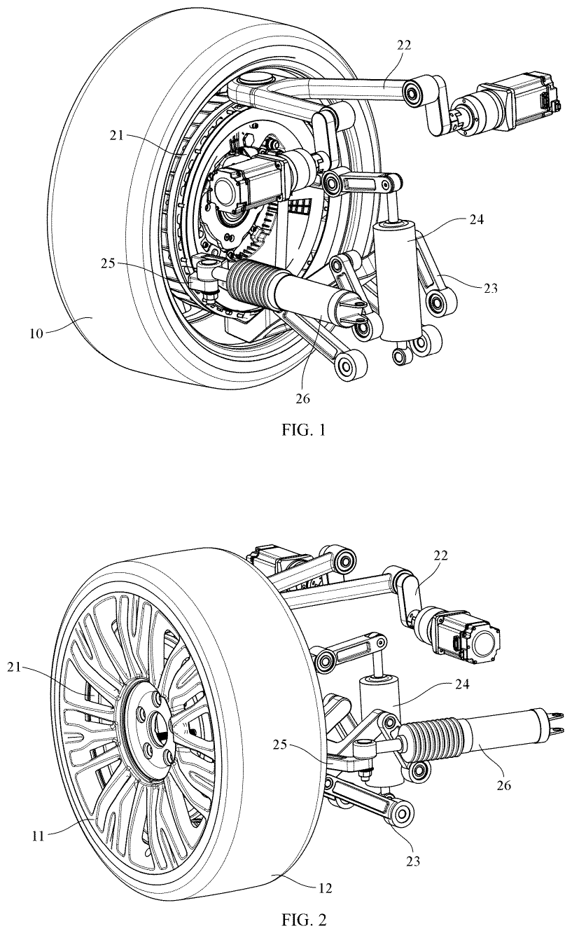

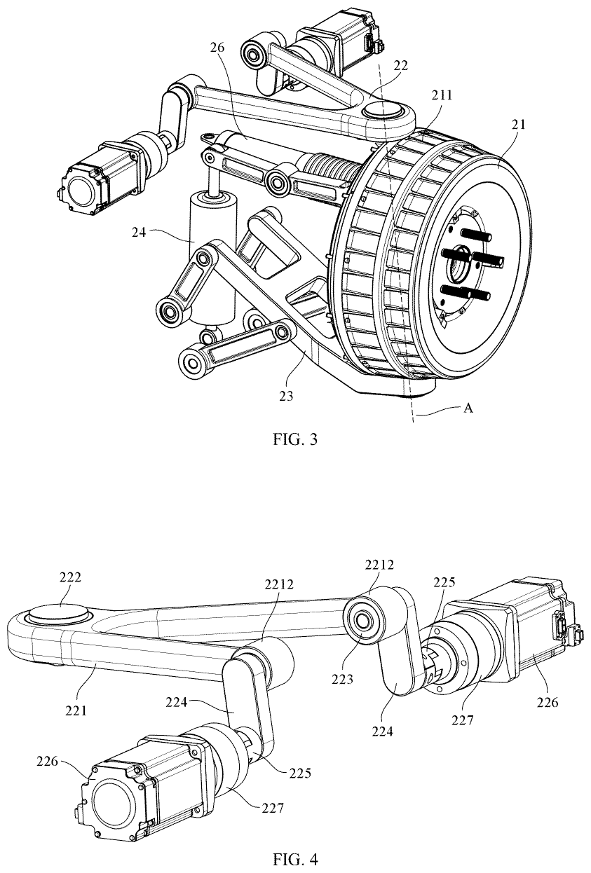

As shown in FIGS. 1 to 3, a multi-degree-of-freedom corner module system for a distributed drive electric chassis provided by an embodiment of the present application includes a wheel hub motor 21, an upper control arm assembly 22, a lower control arm assembly 23, a shock absorber assembly 24, a steering knuckle 25, and a steering mechanism 26.

The wheel hub motor 21 is mounted in a wheel 10. Specifically, the wheel 10 includes a wheel hub 11 and a tire 12. The tire 12 is rigidly connected to a housing of the wheel hub motor 21 through the wheel hub 11. The upper control arm assembly 22, the lower control arm assembly 23, the shock absorber assembly 24, the steering knuckle 25, and the steering mechanism 26 are arranged on one side of the wheel hub motor 21 to form a modular structure.

### One End of the Upper Control Arm Assembly 22 Is Provided With a Multi-directional

rotary connecting assembly and is movably hinged to an upper portion of the housing of the wheel hub motor 21 through the multi-directional rotary connecting assembly. The other end of the upper control arm assembly 22 is connected to at least one of a vehicle body or a vehicle frame 30.

The lower control arm assembly 23 adopts a configuration of an approximately linear mechanism. One end of the lower control arm assembly is hinged to a lower portion of the housing of the wheel hub motor 21 through the multi-directional rotary connecting assembly, and the other end of the lower control arm assembly is connected to at least one of the vehicle body or the vehicle frame 30.

One end of the steering knuckle 25 is hinged to the steering mechanism 26 via a second spherical joint, the other end of the steering knuckle is rigidly connected to a housing of the wheel hub motor 21, and the steering mechanism 26 is configured to drive the steering knuckle 25 to rotate the wheel 10 about a kingpin axis.

In the embodiment of the present application, the steering mechanism 26 may be an actuator capable of providing translational motion, such as an electric cylinder or a hydraulic cylinder, and a specific structure of the steering mechanism 26 is not further described herein. The steering mechanism 26 causes the wheel hub motor 21 and the wheel 10 to rotate around the kingpin axis A through extension and retraction, and the kingpin axis A passes through the center of the multi-directional rotary connecting assembly at ends of the upper control arm assembly 22 and the lower control arm assembly 23. Through a reasonable suspension hard-point arrangement, a lower point of the kingpin axis A extends into an interior of the wheel hub 11, whereby a smaller kingpin offset of the corner module system is achieved, which is beneficial for stability of the distributed drive electric chassis under driving and braking conditions.

In a preferred embodiment of the present application, the corner module system is a three-degree-of-freedom parallel mechanism, including two rotational degrees of freedom and one vertical translational degree of freedom;
the wheel 10 serves as a moving platform of the parallel mechanism, where a steering motion and a cambering motion correspond to the rotational degrees of freedom, and a wheel hopping motion corresponds to the vertical degree of freedom; and
a topology of the parallel mechanism is λS-UPS-RRS, where λ represents a Chebyshev mechanism, S represents a spherical joint, U represents a Hooke joint, R represents a revolute joint, and P represents a prismatic joint.

In the embodiment of the present application, the derivative configurations of the topology include λS-UPS-RPS, λU-UPS-RRU, and λS-PUS-RRS.

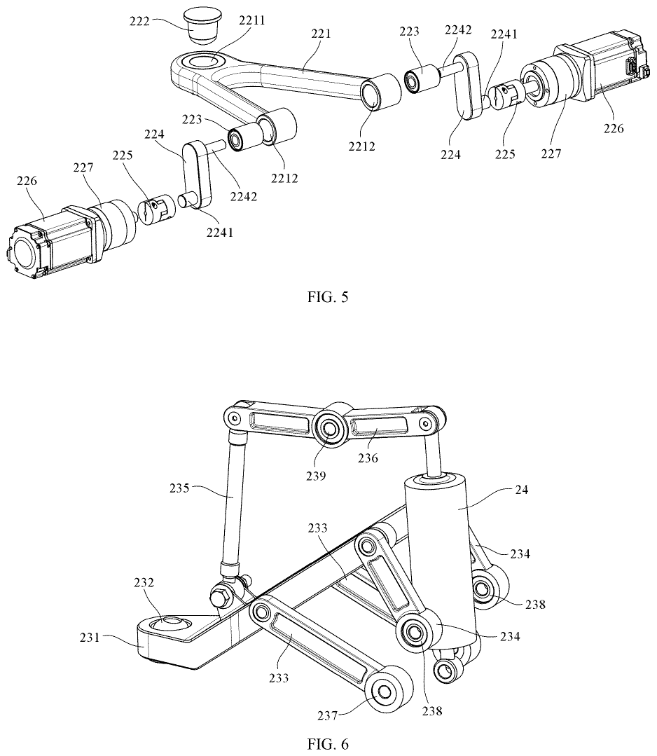

As shown in FIGS. 4 and 5, in a preferred embodiment of the present application, the upper control arm assembly 22 includes an upper control arm body 221, a first spherical joint 222, a first bushing 223, a first connecting rod 224, a coupler 225, a cambering drive motor 226, and a reducer 227.

One end of the upper control arm body 221 is provided with a first mounting hole 2211 for arranging a first spherical joint 222, and the other end of the upper control arm body 221 is provided with a second mounting hole 2212 for assembling the first bushing 223. The upper control arm body 221 and the first bushing 223 may be closely fitted together by pressing, such that no axial displacement exists between the upper control arm body 221 and the first bushing 223.

One end of the first connecting rod 224 is rotatably connected to the first bushing 223 via a second assembly shaft 2242, and the other end of the first connecting rod 224 is connected to the coupler 225 via a first assembly shaft 2241. The coupler 225 transmits the power of the cambering drive motor 226 to the upper control arm body 221, and drives the wheel 10 to rotate around the multi-directional rotary connecting assembly at an end of the lower control arm assembly 23.

The reducer 227 is connected in series with the cambering drive motor 226 to reduce the speed and increase the torque.

In the embodiment of the present application, the reducer 227 may be a planetary gear reducer; the coupler 225 may be a claw-type coupler, a gear coupler, a slider coupler, or the like; and the cambering drive motor 226 may be a brushless DC motor, a permanent magnet synchronous motor, or the like.

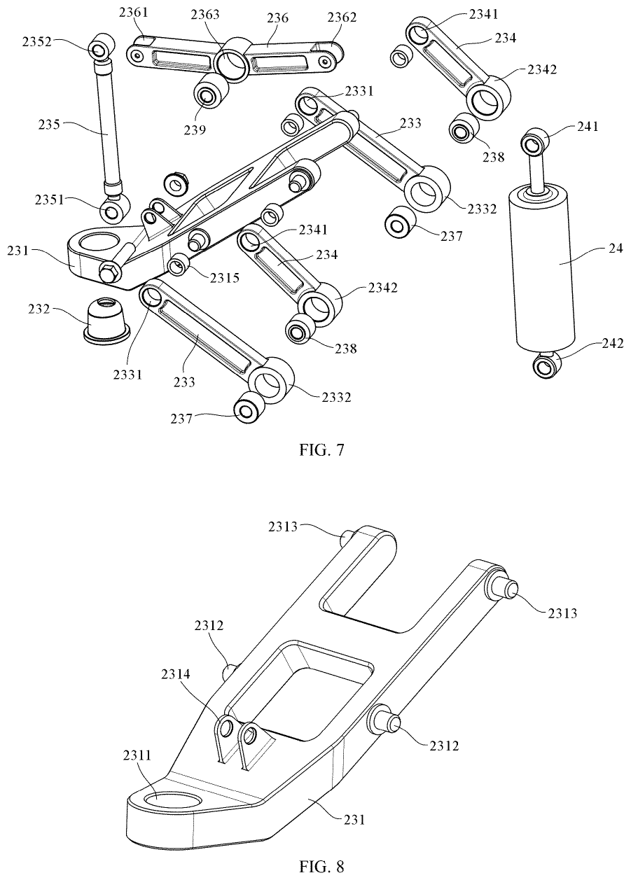

As shown in FIGS. 6 to 8, the lower control arm assembly 23, based on a Chebyshev-lambda mechanism, is an approximately linear mechanism. This structure enables minimal variation of middle wheel positioning parameters during wheel hopping, thereby improving geometrical kinematic characteristics of the suspension. The lower control arm assembly 23 includes a lower control arm body 231, a second spherical joint 232, a second connecting rod 233, a third connecting rod 234, a fourth connecting rod 235, and a fifth connecting rod 236. In addition, the lower control arm assembly 23 also includes a second bushing 237, a third bushing 238, and a fourth bushing 239.

The lower control arm body 231, the second connecting rod 233, and the third connecting rod 234 together form a main portion of the Chebyshev-lambda mechanism. One end of the lower control arm body 231 is provided with a third mounting hole 2311 for arranging the second spherical joint 232, thereby being hinged to the housing of the wheel hub motor 21. Meanwhile, a third assembly shaft 2312 and a fourth assembly shaft 2313 are respectively provided on two sides of the lower control arm body 231. The third assembly shaft 2312 is rotatably connected to a fourth mounting hole 2331 of the second connecting rod 233 via a bearing 2315. The fourth assembly shaft 2313 is rotatably connected to a sixth mounting hole 2341 of the third connecting rod 234 via a bearing 2315. One end of the second connecting rod 233 far away from the lower control arm body 231 is provided with a fifth mounting hole 2332, and the second bushing 237 is fixedly sleeved in the fifth mounting hole 2332 and is rotatably connected to the vehicle frame 30 (or the vehicle body). One end of the third connecting rod 234 far away from the lower control arm body 231 is provided with a seventh mounting hole 2342, and the third bushing 238 is fixedly sleeved in the seventh mounting hole 2342 and is rotatably connected to the vehicle frame 30 (or the vehicle body).

The fourth connecting rod 235, the fifth connecting rod 236, the shock absorber assembly 24, and hinged portions between the above components together constitute a planar single-open-chain mechanism, which is configured to change a transmission path of vertical forces, so that the arrangement position of the shock absorber can be shifted to a wheel side, thereby reducing occupation of vertical space. This configuration facilitates the skateboard chassis with a wide and flat upper deck space. Specifically, one end of the fourth connecting rod 235 is rotatably connected to a first lug structure 2314 of the lower control arm body 231 through an eighth mounting hole 2351, and the other end of the fourth connecting rod 235 is rotatably connected to a second lug structure 2361 of the fifth connecting rod 236 through a ninth mounting hole 2352. Another end of the fifth connecting rod 236 is rotatably connected to an eleventh mounting hole 241 of the shock absorber assembly 24 through a third lug structure 2362; and the fourth bushing 239 is mounted in a tenth mounting hole 2363 formed in a middle portion of the fifth connecting rod 236. Finally, the above single-open-chain mechanism is hinged to the vehicle frame 30 (or vehicle body) through a twelfth mounting hole 242 of the shock absorber assembly 24.

In the embodiment of the present application, the first bushing 223, the second bushing 237, the third bushing 238, and the fourth bushing 239 are all elastic elements and can elastically deform under an external force. These bushings are configured to absorb trajectory errors generated at rod ends during operation of the linkages, improve vehicle ride comfort, and withstand lateral forces during vehicle travel. The bushings are typically made of high-quality aging-resistant rubber materials, such as butyl rubber, fluororubber, or chloroprene rubber.

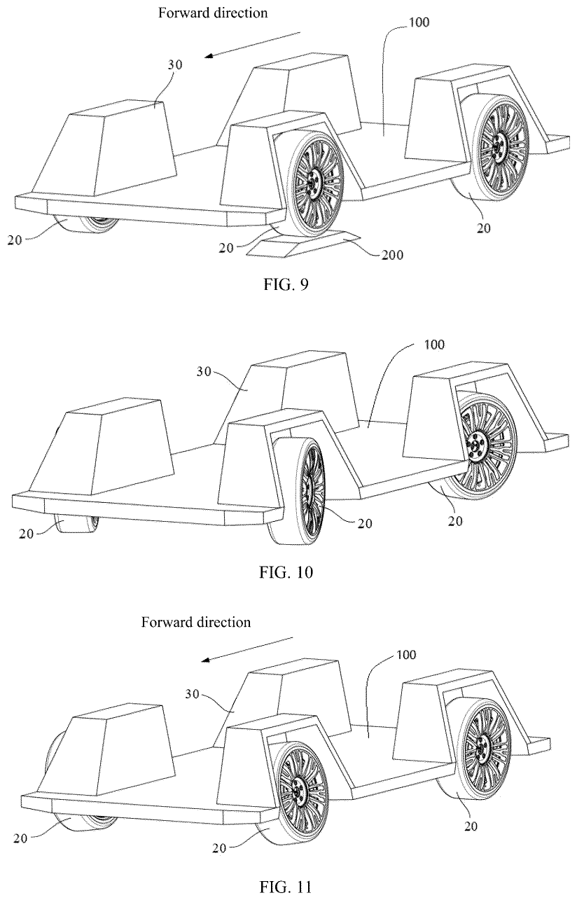

As shown in FIGS. 9 and 10, a skateboard chassis (indicated by reference numeral 100 in the drawings) is provided in an embodiment of the present application. The skateboard chassis is based on the above corner module system and includes a vehicle frame 30, four corner module systems (indicated by reference numeral 20 in the drawings), and wheels 10 configured to mount each corner module system 20.

The wheel 10 includes a wheel hub 11 and a tire 12, the wheel hub motor 21 is fixedly mounted inside the wheel hub 11, and the tire 12 is sleeved on an outer periphery of the wheel hub 11.

In the embodiment of the present application, each wheel 10 is capable of independent steering, enabling the vehicle to achieve front and rear wheels counter-phase steering as shown in FIG. 10. This steering mode can reduce a turning radius and thereby improve vehicle maneuverability. In addition, the skateboard chassis 100 equipped with the corner module system 20 can also achieve diagonal moving, front-wheel steering, rear-wheel steering, and pivot steering, allowing the vehicle to adapt to diversified operating scenarios and working modes. As shown in FIG. 9, in a case where the skateboard chassis 100 passes over a road surface bump, the structure of the corner module system 20 ensures kinematic characteristics of the suspension, thereby reducing variations in positioning parameters of the wheel 10 and minimizing movement of the vehicle frame 30 caused by the hopping of the wheel 10, which would otherwise result in tilting of the vehicle frame 30. Meanwhile, the damping action provided by the shock absorber assembly 24 attenuates excitation from the road surface bump 200, further improving vehicle stability and ride comfort.

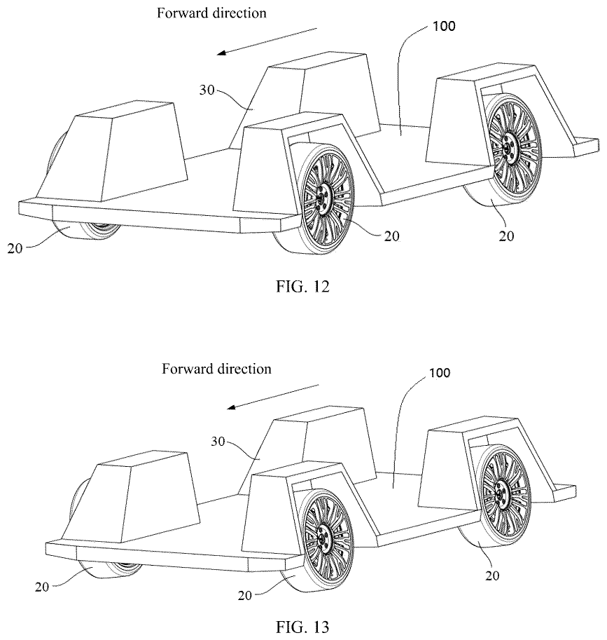

FIGS. 11 to 13 show three different wheel camber configurations of the skateboard chassis 100: front-wheel cambering, rear-wheel cambering, and all-wheel cambering. The introduction of active camber control into the corner module system 20 can significantly improve the stability and safety of the vehicle. For example, inclining a wheel toward an inner side of a curve during cornering allows the tire to generate additional lateral force, thereby expanding the stability margin of the vehicle. In addition, active camber angle adjustment can reduce tire wear, improve wheel adhesion, and compensate for track width variation. In the three wheel camber configurations, front-wheel cambering enables vehicle motion equivalent to front-wheel steering while reducing lateral load transfer. Rear-wheel cambering can simultaneously reduce yaw rate response and lateral displacement of the center of mass. All-wheel cambering can decouple control of yaw response and lateral displacement of the center of mass.

The above mentioned contents are only preferred embodiments of the present application and are not intended to limit the present application. Any modification, equivalent substitution, improvement and the like made within the spirit and principle of the present application shall all fall within the scope of protection of the present application.

What is claimed is:

1. A multi-degree-of-freedom corner module system for a distributed drive electric chassis, comprising: a wheel hub motor, an upper control arm assembly, a lower control arm assembly, a shock absorber assembly, a steering knuckle, and a steering mechanism; wherein
the wheel hub motor is mounted within a wheel hub;
one end of the upper control arm assembly is pivotally hinged above a housing of the wheel hub motor and is capable of performing multi-directional rotation, and the other end of the upper control arm assembly is connected to at least one of a vehicle body or a vehicle frame;
the lower control arm assembly has a function of outputting an approximately linear motion, one end of the lower control arm assembly is hinged below a housing of the wheel hub motor and is capable of performing multi-directional rotation, and the other end of the lower control arm assembly is connected to at least one of a vehicle body or a vehicle frame;
one end of the steering knuckle is hinged to the steering mechanism via a second spherical joint, the other end of the steering knuckle is rigidly connected to a housing of the wheel hub motor, and the steering mechanism is configured to drive the steering knuckle to rotate a wheel about a kingpin axis;
the upper control arm assembly comprises an upper control arm body, a first spherical joint, first bushings, first connecting rods, couplers, cambering drive motors, and reducers;
one end of the upper control arm body is provided with a first mounting hole for arranging a first spherical joint, and the other end of the upper control arm body is provided with a second mounting hole for assembling the first bushing;
one end of the first connecting rod is rotatably connected to the first bushing via a second assembly shaft, and the other end of the first connecting rod is connected to the coupler via a first assembly shaft;
the coupler is configured to transmit power from the cambering drive motor to the upper control arm body, thereby driving the wheel to rotate about an end of the lower control arm assembly;
the reducer is connected in series with the cambering drive motor;
the lower control arm assembly is in a form of a Chebyshev-lambda mechanism;
the Chebyshev-lambda mechanism comprises a lower control arm body, a second connecting rod, and a third connecting rod; one end of the lower control arm body is provided with a third mounting hole for arranging a second spherical joint, thereby being hinged to the housing of the wheel hub motor; two sides of the lower control arm body are respectively provided with a third assembly shaft and a fourth assembly shaft; the third assembly shaft is rotatably connected to a fourth mounting hole of the second connecting rod via a bearing; the fourth assembly shaft is rotatably connected to a sixth mounting hole of the third connecting rod via a bearing; one end of the second connecting rod far away from the lower control arm body is provided with a fifth mounting hole, and a second bushing is fixedly sleeved in the fifth mounting hole and is rotatably connected to the vehicle frame; one end of the third connecting rod far away from the lower control arm body is provided with a seventh mounting hole, and a third bushing is fixedly sleeved in the seventh mounting hole and is rotatably connected to the vehicle frame;
a planar single-open-chain mechanism comprises a fourth connecting rod, a fifth connecting rod, and a shock absorber assembly; one end of the fourth connecting rod is rotatably connected to a first lug structure of the lower control arm body through an eighth mounting hole, and the other end of the fourth connecting rod is rotatably connected to a second lug structure of the fifth connecting rod through a ninth mounting hole; another end of the fifth connecting rod is rotatably connected to an eleventh mounting hole of the shock absorber assembly through a third lug structure; and a twelfth mounting hole on the shock absorber assembly is hinged to the vehicle frame.

2. The multi-degree-of-freedom corner module system for a distributed drive electric chassis according to claim 1, wherein the corner module system is a three-degree-of-freedom parallel mechanism, and has two rotational degrees of freedom and one vertical translational degree of freedom;
the wheel serves as a moving platform of the parallel mechanism, a steering motion and a cambering motion correspond to the rotational degrees of freedom, and a wheel hopping motion corresponds to the vertical translational degree of freedom; and
a topology of the parallel mechanism is λS-UPS-RRS, wherein λ represents a Chebyshev-lambda mechanism, S represents a spherical joint, U represents a Hooke joint, R represents a revolute joint, and P represents a prismatic joint.

3. The multi-degree-of-freedom corner module system for a distributed drive electric chassis according to claim 2, wherein derivative configurations of the topology comprise λS-UPS-RPS, λU-UPS-RRU, and λS-PUS-RRS.

4. A skateboard chassis based on the multi-degree-of-freedom corner module system for a distributed drive electric chassis according to claim 1, comprising a vehicle frame, four corner module systems, and wheels configured to mount each corner module system; wherein
each of the wheels comprises a wheel hub and a tire, the wheel hub motor is fixedly mounted inside the wheel hub, and the tire is sleeved on an outer periphery of the wheel hub.
